(19) United States
(12) Patent Application Publication
(10) Pub. No.: US 2004/0249706 A1
(43) Pub. Date: Dec. 9, 2004

(54) Collaborative campaign execution system

(75) Inventors: Lawrence J. Ellison, Redwood Shores, CA (US); Aman Naimat, Redwood City, CA (US); Max Schireson, Los Altos, CA (US)

Correspondence Address: WILLIAM L SHAFFER, TOWNSEND & TOWNSEND, TWO EMBARCADERO CENTER, 8TH FLOOR, SAN FRANCISCO, CA, 94111-3834, US

(73) Assignee: Oracle Corporation, Redwood Shores, CA (US)

(21) Appl. No.: 10/455,276

(22) Filed: Jun. 4, 2003

(51) Int. Cl. G06F 17/60

(52) U.S. Cl. 705/14

(57) ABSTRACT

A method of executing a marketing campaign. In one embodiment the method comprises selecting collateral for a proposed marketing message and associating the marketing message with a plurality of customers. For each customer in the plurality of customers, a proposed marketing message is generated; a sales representative is assigned to the customer using an automated assignment rule; the customer-to-sales representative assignment made according to the automated assignment rule is electronically communicated to the assigned sales representative and the assigned sales representative is allowed to modify the proposed marketing message for the customer to create a personalized marketing message. The method also includes delivering the personal modified marketing messages to customers.

### BACKGROUND OF THE INVENTION

The present invention relates to a method of and system for executing a marketing campaign. Some specific embodiments of the invention pertain to a method and system that allows sales representatives to participate in generating and delivering personalized marketing messages to customers. Embodiments of the invention are particularly useful for relatively large organizations that have separate marketing and sales departments that include staff numbers in the hundreds or even thousands, but may be useful to any organization that has one or more field sales offices that are in a location separate from the organization's headquarters for sales and/or marketing functions.

Most large companies have separate sales and marketing departments where the marketing department takes the lead in organizing and implementing targeted marketing campaigns to generate sales leads. In carrying out such campaigns the marketing department (i.e., one or more employees working in the marketing department or consultants working for the marketing department) generates an initial target list and contacts the customers on that list en mass through one or more channels such as email, facsimiles, print media, etc. Responses from these “mailings” are captured and forwarded to the sales department for further qualification and follow-up. Eventually such responses may become sales opportunities.

From the perspective of the marketing department (sometimes referred to herein as “marketing”, the above approach is relatively efficient in that marketing campaigns can be conceptualized, generated and carried out in a timely manner. From the perspective of the sales department (sometimes referred to herein as “sales”), however, the above approach is lacking in that the sales division is not brought into the process until after the initial contact has been made.

This sequential lead generation process has two fundamental deficiencies. First, sales is not given the ability to modify and improve the target contact list. As owners of the sales territory, sales employees will generally know their customer base better than their marketing counterparts. Thus, in some instances sales should be able to remove and/or add target contacts as appropriate to minimize wasted mailings and maximize contact opportunity. Second, sales is not given the ability to modify the content (referred to herein as “collateral”) being distributed in the target mailing. Again, sales representatives who know their territories and their customers will generally have a better idea of how their customers should be approached. And although the bulk of the campaign materials (collateral) may be unchanged, slight tweaks in the message delivery or attached collateral may often make a significant difference in customer response.

Accordingly, methods of efficiently allowing sales to actively participate in marketing campaigns as they are being generated are desirable.

### BRIEF SUMMARY OF THE INVENTION

Embodiments of the invention allow marketing to generate a campaign for a given product(s) for a targeted list of customers and allow sales to be efficiently inserted into the campaign generation process prior to delivering the marketing message to prospective customers. Embodiments of the invention allow sales representatives to actively choose the customers they want marketing to deliver the message to and/or modify the collateral included in the marketing message.

One embodiment of the method of the invention comprises selecting collateral for a proposed marketing message and associating the marketing message with a plurality of customers. For each customer in the plurality of customers, a proposed marketing message is generated and a sales representative is assigned to the customer using an automated assignment rule before the message is delivered to the customer. Each proposed marketing message is electronically communicated to its assigned sales representative who is then allowed to modify the proposed marketing message to create a personalized marketing message for the specific customer. Once created, personalized marketing messages may be delivered the customers.

Another embodiment of the method comprises creating a template comprising a plurality of fields for a marketing campaign and storing the template on a computer-readable memory; creating a customer list and storing the customer list on a computer-readable memory; generating a marketing campaign comprising a plurality of proposed marketing messages by populating at least some of the fields in the template with information from the customer list; assigning sales representatives to individual ones of the plurality of proposed marketing messages using an automated assignment rule; electronically communicating the proposed marketing messages to assigned sales representatives; allowing each assigned sales representative to modify the proposed marketing messages assigned to him or her thereby creating a plurality of personalized marketing messages; and delivering the personalized marketing messages to customers.

One embodiment of a system for executing a marketing campaign comprises a template design component configured to allow one or more users to prepare templates for marketing campaigns; a campaign creation component configured to generate a plurality of proposed marketing messages from a template prepared by the template design component and a customer list; a sales component configured to assign a sales representative to each of the plurality of proposed marketing messages, notify sales representatives of proposed marketing messages assigned to them and allow sales representatives to modify the proposed marketing messages; and a delivery component configured to deliver modified marketing messages to customers.

These and other embodiments of the invention along with many of its advantages and features are described in more detail in conjunction with the text below and attached figures.

### BRIEF DESCRIPTION OF THE DRAWINGS

FIG. 1 is a block diagram of a system for creating and executing marketing campaigns according to one embodiment of the invention;

FIG. 2 is a flowchart depicting steps associated with creating, modifying and executing marketing campaigns according to one embodiment of the invention; and

FIGS. 3A-3D are exemplary Web and email messages that are generated by system 10 to facilitate the creation and execution of a marketing campaign according to one embodiment of the method of the invention set forth in FIG. 2.

### DETAILED DESCRIPTION OF THE INVENTION

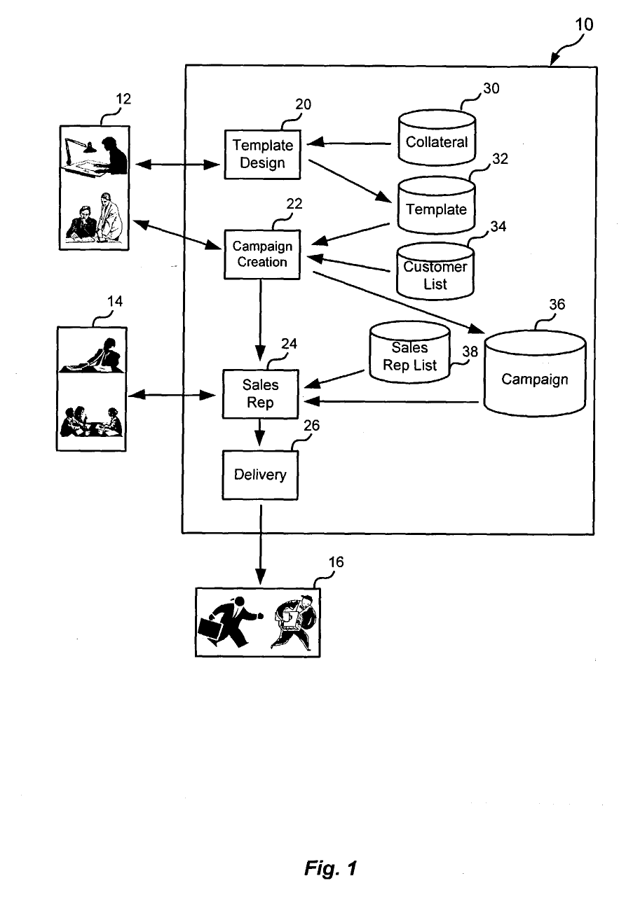

FIG. 1 is a block diagram of a system 10 for creating and executing marketing campaigns according to one embodiment of the invention. System 10 allows users 12 associated with an organization's marketing department to create marketing campaigns. System 10 also allows users 14 associated with the organization's sales department to accept, modify or reject the marketing messages generated as part of the campaign as well as accept, modify or reject the customers 16 targeted to receive the marketing messages prior to the delivery of the marketing messages to customers 16. System 10 is particularly useful for relatively large organizations that have separate marketing and sales departments that include staff numbers in the hundreds in even thousands, but may also be useful to any organization that has one or more field sales offices that are in separate location from the organezation's headquarters for sales and/or marketing functions.

As used herein a marketing campaign is a collection of proposals or offers put together on behalf of an organization and sent to perspective customers. The organization is typically, but not necessarily, a commercial entity that sells products and/or services to customers and thus the proposals typically include information describing the product and/or service for sale. The customers may include other commercial entitities, government organizations and/or individuals that are the targets of the marketing campaign.

In addition to information on the products and/or services being offered through the marketing campaign, the proposals generated for the campaign typically include other material as well such as data sheets, white papers, electronic presentations, return on investment (ROI) studies, statements of direction, customer references and/or testimonials and the like. As used herein, the term “collateral” refers to any material that is part of the marketing message and that is intended to help secure a sale of the product and/or service to a perspective customer.

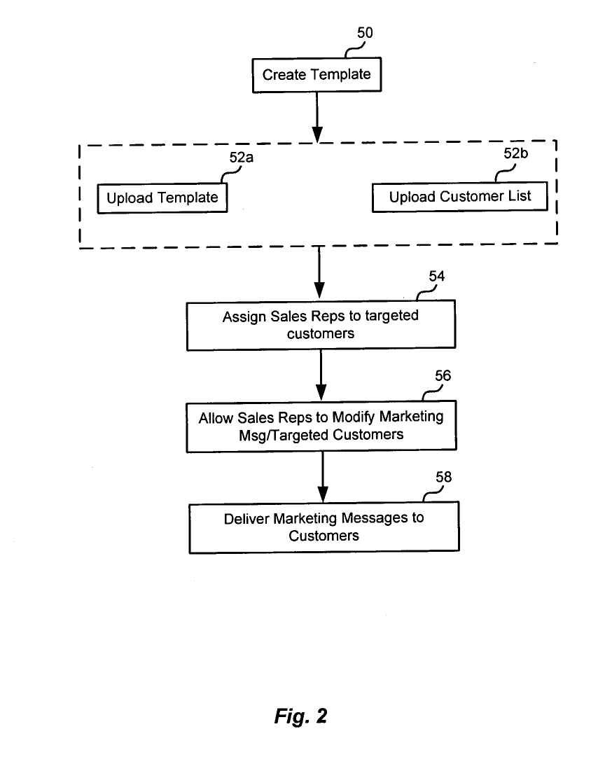

Referring to FIGS. 1 and 2, system 10 includes a number of different logical components that are hosted on a computer system, which may include a number of distributed server systems and client systems. The logical components, which for illustrative purposes are shown as template design component 20, campaign creation component 22, sales representative component 24 and campaign delivery component 26, are executed by users 12 and 14 and allow the users to create, modify and execute marketing campaigns in a time efficient manner. It is to be understood that components 20, 22, 24, 26 are logically represented in FIG. 1 and that system 10 can include fewer, more or differently arranged logical components.

Users 12 and 14 communicate with system 10 using client systems (not shown), such as personal computers. Such client systems may be connected to system 10 over any suitable communication network including a local area network (LAN), a wide area network (WAN), a wireless network, an intranet, a private network, a public network, a switched network or the like. In some embodiments, some or all of the client systems may communicate with system 10 over secure channels via the Internet.

One or more users 12 create marketing campaigns for particular products and/or services (or collections of products and/or services) by first creating a template for each campaign using template design component 20 (FIG. 2, step 50). Typically users 12 are employees in the organization's marketing department, but users 12 may also include consultants, contract workers and others. For each particular campaign, template design component 20 allows users 12 to define the marketing message that will be communicated to customers 16 by the campaign. The marketing message is defined by the collateral that users 12 select for the campaign.

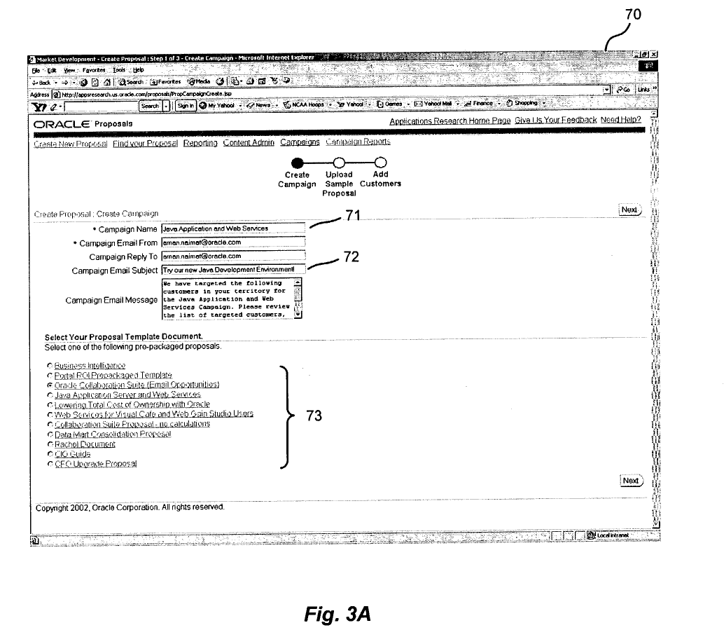

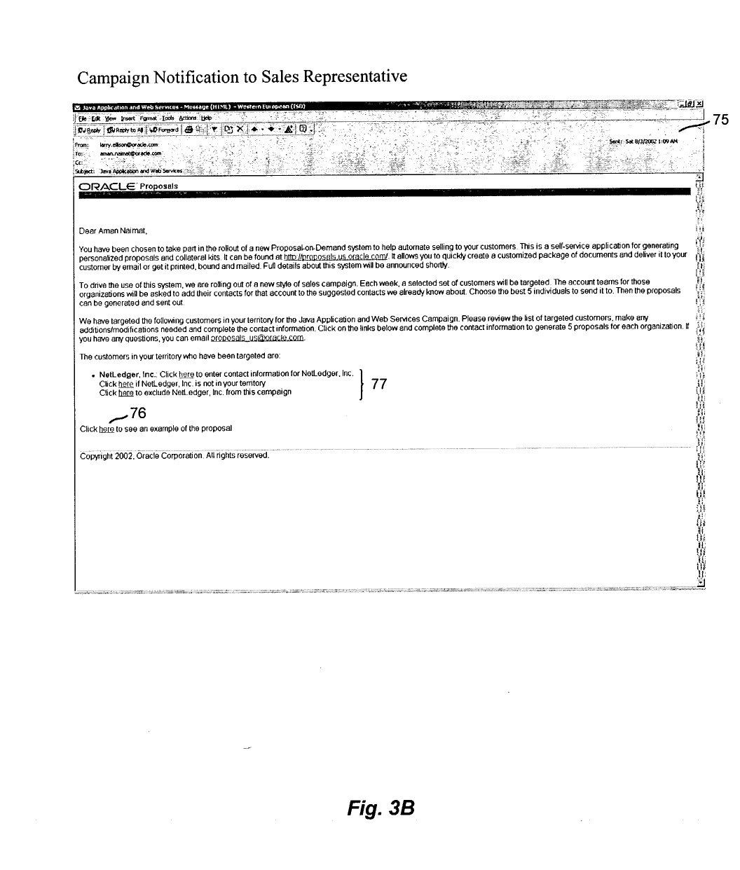

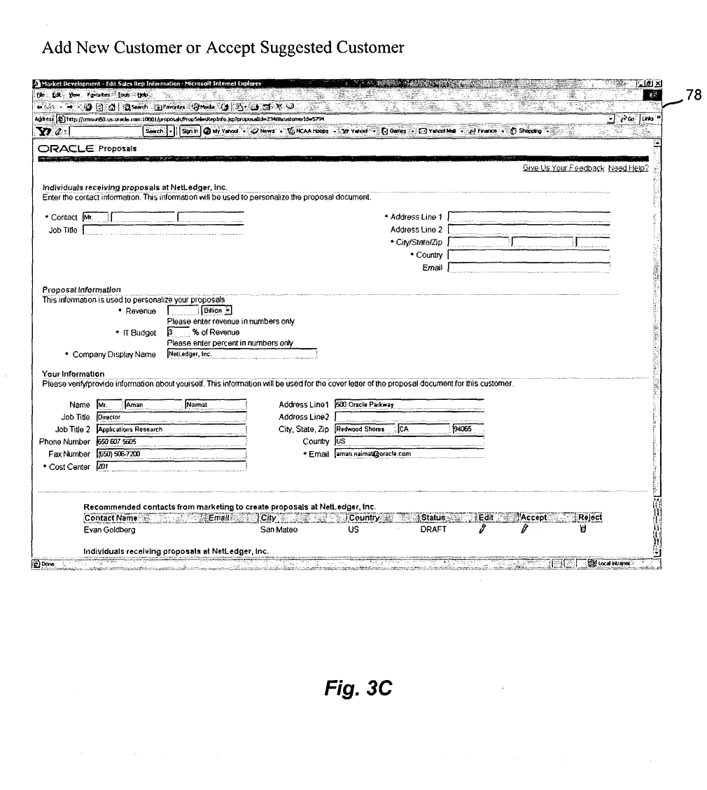

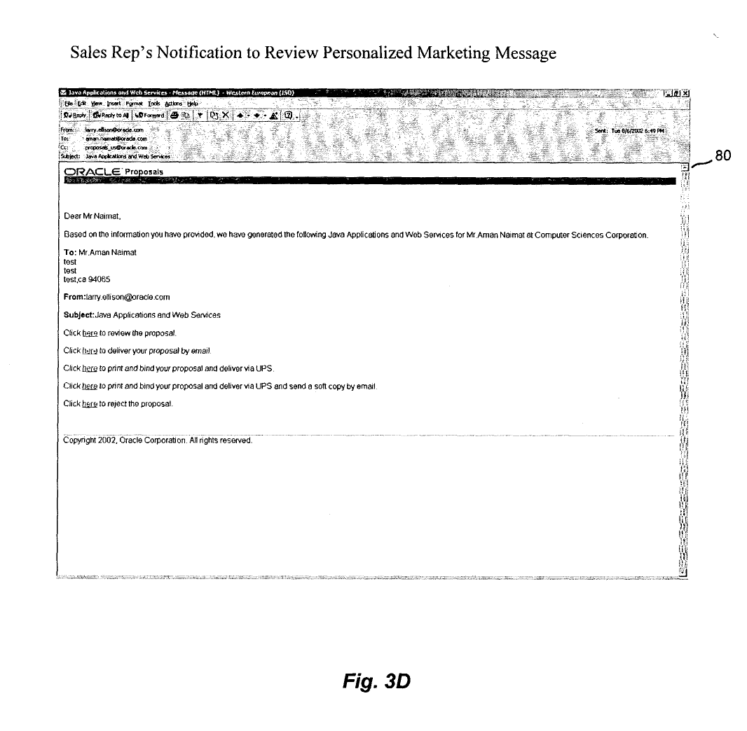

FIG. 3A is an exemplary web page 70 that can be generated by one embodiment of template design component 20 to facilitate the preparation of a marketing campaign templates. Web page 70 allows users 12 to name the campaign (field 71), identify the products and/or services that are the subject of the campaign (field 72) and select from one or more pre-packaged marketing messages (part of collateral 30) that have been developed for the selected products and/or services (fields 73). Some embodiments of the invention allow users 12 to modify the pre-packaged marketing message by adding additional collateral, removing some of the collateral included in the previously prepared package or otherwise modifying the collateral selected for the campaign. Users 12 may also create the marketing message from scratch without relying on pre-packaged collateral by attaching appropriate collateral to the campaign and/or by designing new collateral for the campaign. The pre-packaged material marketing material and other collateral used in the marketing campaign and shown as collateral 30 is stored on a computer-readable memory.

After the one or more users 12 have created the template for a particular marketing campaign, the template is stored as template 32. A user 12 then selects a customer list 34 that will be associated with the template and used to generate an initial version of the marketing campaign. As a person of skill in the art would appreciate, customer list 34 may be a list of customers that was previously identified by the marketing department as appropriate targets for the campaign, may be a list of customers that was created specifically for the campaign or may be any other appropriate list of potential targets for the products and/or services marketed by the campaign.

Campaign creation component 22 accepts customer list 34 as input and uses template 32 to create a proposed marketing campaign stored as campaign 36 (FIG. 2, step 54). This can be done, for example, when a user 12 uploads template 32 and customer list 34 into campaign creation component 22 (FIG. 2, steps 52a and 52b, respectively) and selects an option to “create campaign.” In one embodiment campaign creation component 22 creates campaign 36 by populating fields of template 32 defined by users 12 with data from customer list 34. Once it is created, proposed campaign 36 is theoretically ready for delivery to customers 16 by delivery component 28.

Embodiments of the invention, however, allow for sales representatives to improve and/or customize the content of the proposed marketing messages that make up proposed campaign 36. To this end, a sales rep component 24 assigns a sale representative to each proposed marketing message that is included in campaign 36 according to an assignment rule (FIG. 2, step 56). As used here, a “proposed marketing message” is a customer specific message that has been generated by campaign creation component 22. Campaign 36 includes a plurality of proposed marketing messages-generally one proposed marketing message for each customer that was included in the customer list 34 used by component 22 to create campaign 36. In one embodiment, the assignment rule used by component 24 in making assignments is based on pre-defined sales territories. In another embodiment, the assignment rule is based on a combination of pre-defined sales territories and existing customer relationships. A person of skill in the art will appreciate that variations of these rules or other rules altogether can be used in other embodiments. The list of possible sales representatives along with information used by the assignment rule such as each sales representative's territory and/or existing customer list can be stored in one or more database tables 38.

Sales rep component 24 then notifies the appropriate sales representatives (one of users 14) that one or more proposed marketing messages in the campaign have been assigned to the representative's customers (FIG. 2, step 58). In one embodiment the routing is performed by email notification. FIG. 3B shows an exemplary email 75 that can be generated and sent by component 24. As shown in FIG. 3B, email notification 75 is a personalized message that is generated for each sales representative. Email 75 describes the intent and purpose of the marketing campaign (as described by a user 12 through, e.g., entries in Web page 70 in FIG. 3A), and includes an embedded link 76 in the email that allows the representative to review and revise the marketing message and associated collateral that are stored somewhere else on the organization's network (FIG. 2, step 60).

Revisions to the message and collateral for each targeted customer can be done, for example, by adding personalized messages, removing some collateral from the marketing message and/or adding additional collateral to the message. The email notification also includes a listing 77 of the one or more customers the sales representative has been assigned to for the marketing campaign and an embedded link for each customer that allows the sales representative to change the targeted contact at the customer, accept the customer or reject the customer and add one or more new customers. Changing or otherwise modifying the targeted customer and/or collateral included in the marketing message updates campaign 36 with the newly entered information for the specific customer, while rejecting the customer removes the customer from marketing campaign and thus ensures the rejected customer will not receive the marketing message. As used herein, revisions to the message and/or collateral entered in step 60 for a customer allow a sales representative to turn a proposed marketing message for the customer into a personalized marketing message for the customer, i.e., a marketing message that has had at least a portion of the message reviewed and in some manner modified by the sales representative in hopes of improving the customer's response to the message.

FIG. 3C is an example of a web page 78 that allows a user 14 to edit the targeted contact information for a given customer. All updates to marketing messages entered by sales representatives 14 are stored in campaign 32. In this manner sales rep component 24 allows users 14 to modify the content and/or recipients of specific marketing messages that will ultimately be sent to their customers prior to the delivery of these messages to the customers. Some embodiments of the invention also allow a sales representative to assign the customer to a different representative. If this action is selected, system 10 removes the customer name from the original sales representative, adds the customer name to the new representative and generates a new notification that is communicated to the new representative who then has the same options (e.g., modify, accept or reject the message) as presented to the original sales representative.

Prior to the delivery of modified marketing messages, component 24 allows users 14 to review and approve (or continue to modify) the modified message. FIG. 3D is an exemplary email message 80 that can be sent by component 24 in one embodiment of the invention to allow the sales representative to review and approve the modified message. As shown in FIG. 3D, the sales representative is also able to select one of several different methods for the marketing message to be delivered.

Once an individual sales representative is satisfied with the marketing message for one of his or her customers 16, the representative indicates to component 24 that the message is ready for delivery, for example, by selecting an appropriate delivery method. Component 24 then invokes delivery component 26, which delivers the marketing message to the customer (FIG. 2, step 62).

When the delivery method chosen is via email in order to allow for immediate communication of the personalized marketing messages to customers, each personalized message is sent from system 10 to an email address associated with the targeted customer 16 via the Internet. Customer 16 can then view the marketing message using an email application. In some embodiments the collateral associated with the personalized message is attached to the email as an attachment and can be reviewed by customer 16 with the email application or with a viewer program appropriate for the type of attachment (e.g., Adobe Acrobat for PDF files). In other embodiments the collateral associated with the personalized message is stored on servers associated with system 10 and the email notification includes a reference, e.g., an HTML link, to the collateral so it can be accessed from system 10 by the customer.

Having fully described several embodiments of the present invention, other equivalent or alternative methods of practicing the present invention will be apparent to those skilled in the art. For example, while system 10 was described as a distributed system, the system may be deployed in various other environments such as an enterprise environment, a stand-alone system, and the like. Also, while the present invention has been described using a particular combination of hardware and software, it should be recognized that other combinations of hardware and software are also within the scope of the invention. Specifically, the invention may be implemented primarily in hardware, primarily in software, or using appropriate combinations thereof. These and other embodiments as well as alternatives and equivalents to the invention will be recognizable to those of skill in the art after reading the description of the present invention. The scope of the invention should not, therefore, be determined solely by reference to the above description, but instead should be determined with reference to the appended claims along with their full scope of equivalents and alternatives.

What is claimed is:

1. A method of executing a marketing campaign, the method comprising:
selecting collateral for a proposed marketing message;
associating the marketing message with a plurality of customers;
for each customer in the plurality of customers, (i) generating a proposed marketing message; (ii) assigning a sales representative to the customer using an automated assignment rule; (iii) electronically communicating the customer-to-sales representative assignment made according to the automated assignment rule to the assigned sales representative and (iv) allowing the assigned sales representative to modify the proposed marketing message for the customer to create a personalized marketing message; and
delivering personal modified marketing messages to customers.

2. The method of executing a marketing campaign set forth in claim 1 wherein the collateral comprises one or more of data sheets, white papers, electronic presentations and other electronic documents related to a product being sold by the marketing campaign.

3. The method of executing a marketing campaign set forth in claim 1 wherein the assignment rule assigns sales representatives to customers based on sales territories.

4. The method of executing a marketing campaign set forth in claim 1 wherein the assignment rule takes into account both sales territories and existing relationships between customers and sales representatives.

5. The method of executing a marketing campaign set forth in claim 1 wherein the proposed marketing message is communicated to the sales representative by an email notification.

6. The method of executing a marketing campaign set forth in claim 1 wherein the customer list includes contact information for each customer and wherein, for each customer-to-sales representative assignment made according to the automated assignment rule, the contact information is communicated to the sales representative and the sales representative is able to modify the contact information prior to delivery of the personalized marketing message.

7. The method of executing a marketing campaign set forth in claim 6 wherein the sales representative can review and approve the personalized marketing message prior to delivery to the customer.

8. The method of executing a marketing campaign set forth in claim 1 wherein the personalized marketing messages are delivered to customers via email.

9. The method of executing a marketing campaign set forth in claim 8 wherein each email message forwarding a personalized marketing message to a targeted customer includes references to collateral included in the personalized marketing message.

10. A method of executing a marketing campaign, the method comprising:
creating a template comprising a plurality of fields for a marketing campaign and storing the template on a computer-readable memory;
creating a customer list and storing the customer list on a computer-readable memory;
generating a marketing campaign comprising a plurality of proposed marketing messages by populating at least some of the fields in the template with information from the customer list;
assigning sales representatives to individual ones of the plurality of proposed marketing messages using an automated assignment rule;
electronically communicating the proposed marketing messages to assigned sales representatives;
allowing each assigned sales representative to modify the proposed marketing messages assigned to him or her thereby creating a plurality of personalized marketing messages; and
delivering the personalized marketing messages to customers.

11. The method of claim 10 further comprising allowing an assigned sales representative to review and approve a personalized marketing message prior to delivering the personalized marketing message to the customer.

12. The method of claim 10 wherein the step of creating the template includes creating a message to sales representatives describing the marketing campaign.

13. The method of claim 12 wherein the message to the sales representatives is electronically communicated to an assigned sales representative along with the proposed marketing message.

14. The method of claim 10 further comprising allowing a sales representative to reassign a proposed marketing message to another sales representative.

15. A system for executing a marketing campaign, the system comprising:
a template design component configured to allow one or more users to prepare templates for marketing campaigns;
a campaign creation component configured to generate a plurality of proposed marketing messages from a template prepared by the template design component and a customer list;
a sales component configured to assign a sales representative to each of the plurality of proposed marketing messages, notify sales representatives of proposed marketing messages assigned to them and allow sales representatives to modify the proposed marketing messages; and
a delivery component configured to deliver modified marketing messages to customers.

16. The system of claim 15 wherein the sales component is configured to assign sales representatives to each of the plurality of proposed marketing messages based upon an assignment rule.

17. A system for executing a marketing campaign, the system comprising:
template design means for allowing one or more users to prepare templates for marketing campaigns;
campaign creating means for generating a plurality of proposed marketing messages from a template prepared by the template design means and a customer list;
sales component means for assigning a sales representative to each of the plurality of proposed marketing messages, notifying sales representatives of proposed marketing messages assigned to them and allowing sales representatives to modify the proposed marketing messages; and
message delivery means for delivering marketing messages to customers.
